(19) United States
(12) Patent Application Publication
(10) Pub. No.: US 2026/0196879 A1
(43) Pub. Date: Jul. 9, 2026

(54) WIRELESS POWER RECEIVING DEVICE

(71) Applicant: Murata Manufacturing Co., Ltd., Kyoto-fu (JP)

(72) Inventors: Koyo KAIWA, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 19/557,934

(22) Filed: Mar. 5, 2026

Related U.S. Application Data
(63) Continuation of application No. PCT/JP2024/022406, filed on Jun. 20, 2024.

(30) Foreign Application Priority Data
Sep. 29, 2023 (JP) 2023-169841

(51) Int. Cl. H02J 50/12

(52) U.S. Cl. CPC H02J 50/12

(57) ABSTRACT

A wireless power receiving device includes a thermally conductive member, first, second and third magnetic sheets, a power receiving coil, a power-receiving circuit board, and a heat-generating electronic component. The thermally conductive member has an annular shape, and extends in the circumferential direction about one direction. The first magnetic sheet extends along the outer periphery of the thermally conductive member, and is in contact with the thermally conductive member. The second magnetic sheet covers an opening at one side of the thermally conductive member. The third magnetic sheet covers an opening at the other side of the thermally conductive member. The power receiving coil is wound around the outer periphery of the first magnetic sheet. The power-receiving circuit board is inward of the thermally conductive member, and is electrically connected to the power receiving coil to supply power to a load.

### CROSS-REFERENCE TO RELATED APPLICATIONS

This application claims benefit of priority to International Patent Application No. PCT/JP 2024/022406, filed Jun. 20, 2024, and to Japanese Patent Application No. 2023-169841, filed Sep. 29, 2023, the entire contents of each are incorporated herein by reference.

### BACKGROUND

### Technical Field

The present disclosure relates to a wireless power receiving device.

Background Art

To charge a secondary battery installed in small electronic devices, wireless power supply technology is used in which electric power is wirelessly supplied to such an electronic device from an external power transmitting device. Electronic devices employing such wireless power supply technology do not need to include a charging terminal. This allows such an electronic device to be free from problems such as corrosion or degradation of its metal terminal (charging terminal) and to have improved waterproof performance.

As such wireless power supply technology, Japanese Unexamined Patent Application Publication No. 2015-015860 describes a power receiving/supply device and a mobile device. International Publication No. 2017/145266 describes a contactless power supply device and a contactless wireless power transfer device.

### SUMMARY

Preferably, small electronic devices using wireless power supply technology employ a hermetically sealed housing structure to provide waterproof performance.

Electronic devices incorporate a power conversion circuit to charge a secondary battery with power obtained at a power receiving coil. A semiconductor device (IC) constituting such a power conversion circuit generates heat.

When an electronic device employs a hermetically sealed structure and its semiconductor element constituting the power conversion circuit generates heat as described above, this leads to an elevated temperature rise in a localized area (near the power conversion circuit) of the surface of the housing of the electronic device.

In such an electronic device, magnetic flux linkage with a component such as a wireless power receiving circuit or a secondary battery may cause the wireless power receiving circuit or the secondary battery to, for example, generate heat or become susceptible to electromagnetic interference. This results in reduced magnetic coupling to a power transmitting coil, and thus reduced power reception efficiency of such an electronic device.

In view of the foregoing, embodiments according the present disclosure reduce a localized increase in the temperature of the surface of the housing, reduce electromagnetic interference, and improve power reception efficiency.

A wireless power receiving device according to an aspect of the present disclosure includes a thermally conductive member having an annular shape, the thermally conductive member extending in a circumferential direction about one direction; a first magnetic sheet extending along an outer periphery of the thermally conductive member and in thermal contact with the thermally conductive member; a second magnetic sheet covering an opening at one side in the one direction of the thermally conductive member; and a third magnetic sheet covering an opening at a side opposite to the one side in the one direction of the thermally conductive member. The wireless power receiving device further comprises a power receiving coil wound around an outer periphery of the first magnetic sheet; a power-receiving circuit board disposed inward of the thermally conductive member and electrically connected to the power receiving coil, the power receiving circuit board being configured to rectify and convert a resonant current induced in the power receiving coil into a direct current to supply power to a load; and a heat-generating electronic component mounted to the power-receiving circuit board and in thermal contact with the thermally conductive member. The thermally conductive member is configured to conduct heat generated from the heat-generating electronic component to the first magnetic sheet. The first magnetic sheet has a length in the one direction greater than a distance between a major face of the second magnetic sheet and a major face of the third magnetic sheet, the major face of the second magnetic sheet being a major face at the one side in the one direction, the major face of the third magnetic sheet being a major face at the side opposite to the one side in the one direction. The first magnetic sheet is configured to form a main magnetic flux path and to thermally radiate the heat generated from the heat-generating electronic component, the main magnetic flux path being a magnetic path that exhibits greater magnetic coupling to a magnetic flux generated from a power transmitting coil external to the wireless power receiving device than a magnetic path formed in the second magnetic sheet or the third magnetic sheet.

The present disclosure makes it possible to reduce an increase in the temperature of the heat-generating component mounted to the power-receiving circuit, reduce a localized increase in the temperature of the surface of the housing, and suppress eddy current-induced heat generation of the wireless power receiving circuit or the secondary battery to reduce electromagnetic interference and consequently improve power reception efficiency.

### BRIEF DESCRIPTION OF THE DRAWINGS

FIG. 1 illustrates the principle of wireless power transmission/reception;

FIG. 2 is a circuit block diagram of a wireless power receiving device according to an embodiment;

FIG. 3 illustrates the outward appearance of the wireless power receiving device according to the embodiment;

FIG. 4 illustrates the outward appearance of the wireless power receiving device according to the embodiment;

FIG. 5 illustrates the internal structure of the wireless power receiving device.

FIG. 6 illustrates the internal structure of the wireless power receiving device.

FIG. 7 illustrates the internal structure of the wireless power receiving device.

FIG. 8 illustrates an example of a first magnetic sheet.

FIG. 9 illustrates an example of a second magnetic sheet.

FIG. 10 illustrates an example of a third magnetic sheet.

FIG. 11 illustrates a first example of magnetic fluxes that link with the wireless power receiving device; and

FIG. 12 illustrates a second example of magnetic fluxes that link with the wireless power receiving device.

### DETAILED DESCRIPTION

Embodiments of the present disclosure are described below in detail with reference to the drawings. These embodiments, however, are not intended to be limiting of the present disclosure. It is needless to mention that embodiments described below are for illustrative purposes only, and structural features presented in different embodiments may be substituted for or combined with each other. In second and subsequent embodiments, matters or features identical to those of a first embodiment are not described in further detail, and only differences from the first embodiment are described. In particular, the same or similar operational effects provided by the same or similar structural features are not mentioned for each individual embodiment.

### Embodiments

### Principle of Wireless Power Transmission/Reception

Prior to describing a wireless power receiving device according to an embodiment, the principle of wireless power transmission/reception will be described.

### Configuration

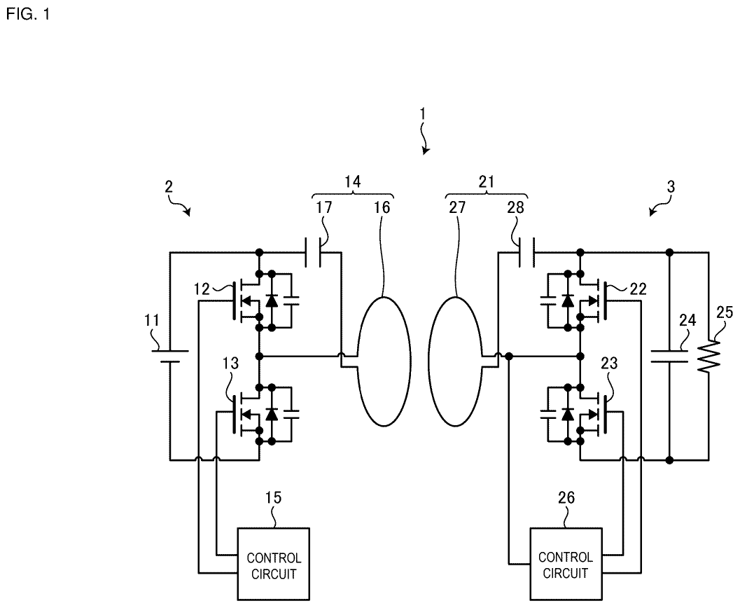

FIG. 1 illustrates the principle of wireless power transmission/reception. A wireless power transmitting/receiving device 1 includes a wireless power transmitting device 2, and a wireless power receiving device 3.

The wireless power transmitting device 2 includes a direct-current power source 11, a transistor 12, a transistor 13, a power-transmitting resonant circuit 14, and a control circuit 15. The transistor 12 and the transistor 13 each have a parasitic capacitor and a parasitic diode. The power-transmitting resonant circuit 14 includes a power transmitting coil 16, and a resonant capacitor 17.

The wireless power receiving device 3 includes a power-receiving resonant circuit 21, a transistor 22, a transistor 23, a smoothing capacitor 24, a load 25, and a control circuit 26. The transistor 22 and the transistor 23 each have a parasitic capacitor and a parasitic diode. The power-receiving resonant circuit 21 includes a power receiving coil 27, and a resonant capacitor 28.

The drain of the transistor 12 is electrically connected to the high potential-side terminal of the direct-current power source 11. The source of the transistor 12 is electrically connected to the drain of the transistor 13. The source of the transistor 13 is electrically connected to the low potential-side terminal of the direct-current power source 11. One end of the resonant capacitor 17 is electrically connected to the drain of the transistor 12. The other end of the resonant capacitor 17 is electrically connected to one end of the power transmitting coil 16. The other end of the power transmitting coil 16 is electrically connected to the source of the transistor 12 and to the drain of the transistor 13.

One end of the power receiving coil 27 is electrically connected to one end of the resonant capacitor 28. The other end of the resonant capacitor 28 is electrically connected to the drain of the transistor 22. The source of the transistor 22 is electrically connected to the other end of the power receiving coil 27 and to the drain of the transistor 23. One end of the smoothing capacitor 24 is electrically connected to the drain of the transistor 22. The other end of the smoothing capacitor 24 is electrically connected to the source of the transistor 23. One end of the load 25 is electrically connected to the one end of the smoothing capacitor 24. The other end of the load 25 is electrically connected to the other end of the smoothing capacitor 24.

The power-transmitting resonant circuit 14 and the power-receiving resonant circuit 21 are electromagnetically coupled to each other.

### Operation

The control circuit 15 causes the transistor 12 and the transistor 13 to alternately turn on and off at a predetermined switching frequency. A rectangular-wave (pulse) voltage is thus applied to the power-transmitting resonant circuit 14. As a result, the power-transmitting resonant circuit 14 resonates, and a resonant current flows in the power-transmitting resonant circuit 14.

When the power-transmitting resonant circuit 14 resonates, the power-transmitting resonant circuit 14 and the power-receiving resonant circuit 21 resonate with each other. That is, the power-receiving resonant circuit 21 resonates. This causes a resonant current to flow in the power-receiving resonant circuit 21.

In a non-limiting example of the present disclosure, the magnetic field generated from the power-transmitting resonant circuit 14 may have a frequency of 6.78 MHz or 13.56 MHz in the Industrial, Scientific and Medical (ISM) band.

The control circuit 26 causes the transistor 22 and the transistor 23 to alternately turn on and off depending on the direction in which current flows in the power receiving coil 27. As a result, the resonant current of the power-receiving resonant circuit 21 is rectified in synchronization with the direction in which current flows. The smoothing capacitor 24 smooths the rectified current. A voltage obtained through the smoothing at the smoothing capacitor 24 is applied to the load 25.

### Circuit Block Configuration of Wireless Power Receiving Device

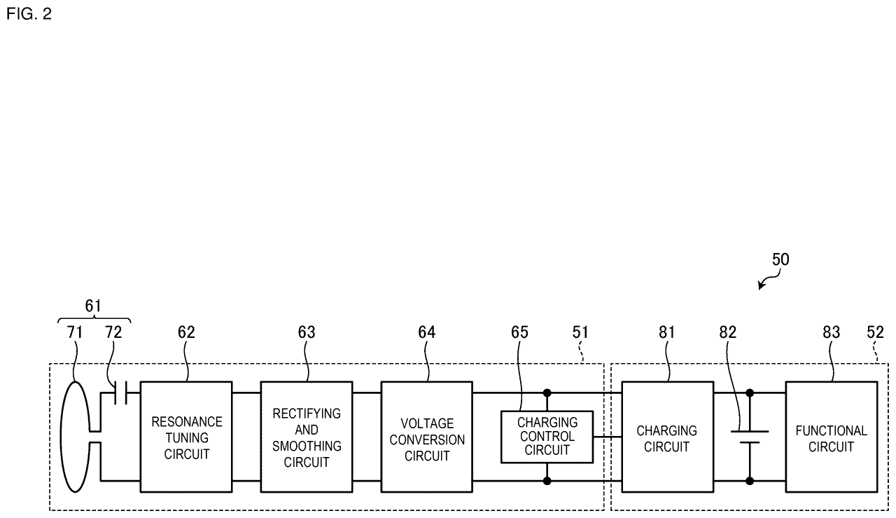

FIG. 2 is a circuit block diagram of the wireless power receiving device according to the embodiment.

A wireless power receiving device 50 includes a wireless power receiving circuit 51, and a load circuit 52. The wireless power receiving circuit 51 include a power-receiving resonant circuit 61, a resonance tuning circuit 62, a rectifying and smoothing circuit 63, a voltage conversion circuit 64, and a charging control circuit 65. The power-receiving resonant circuit 61 includes a power receiving coil 71, and a resonant capacitor 72. The load circuit 52 includes a charging circuit 81, a secondary battery 82, and a functional circuit 83.

The resonance tuning circuit 62 is configured to tune the resonance of the power-receiving resonant circuit 61. In an exemplary configuration, the resonance tuning circuit 62 corresponds to the transistor 22, the transistor 23, and the control circuit 26 that are illustrated in FIG. 1.

The rectifying and smoothing circuit 63 smooths and rectifies the resonant current of the power-receiving resonant circuit 61. In an exemplary configuration, the rectifying and smoothing circuit 63 corresponds to the smoothing capacitor 24 illustrated in FIG. 1. The rectifying and smoothing circuit 63 may include a component such as a diode in addition to the smoothing capacitor 24.

In an exemplary configuration, the voltage conversion circuit 64 is a switching regulator configured to step up or step down a voltage obtained through the rectification and the smoothing at the rectifying and smoothing circuit 63.

The charging control circuit 65 controls the charging circuit 81, and causes the charging circuit 81 to charge the secondary battery 82.

The functional circuit 83 is configured to operate by receiving power supplied from the secondary battery 82. In an exemplary configuration, when the wireless power receiving device 50 is a hearing aid, the functional circuit 83 may be a circuit board configured to amplify an audio signal and output the amplified audio signal.

### Housing of Wireless Power Receiving Device

The following description of the embodiment is directed, but not limited, to a case where the wireless power receiving device according to the present disclosure is applied to a hearing aid. The wireless power receiving device according to the present disclosure is applicable to a wide variety of electronic devices.

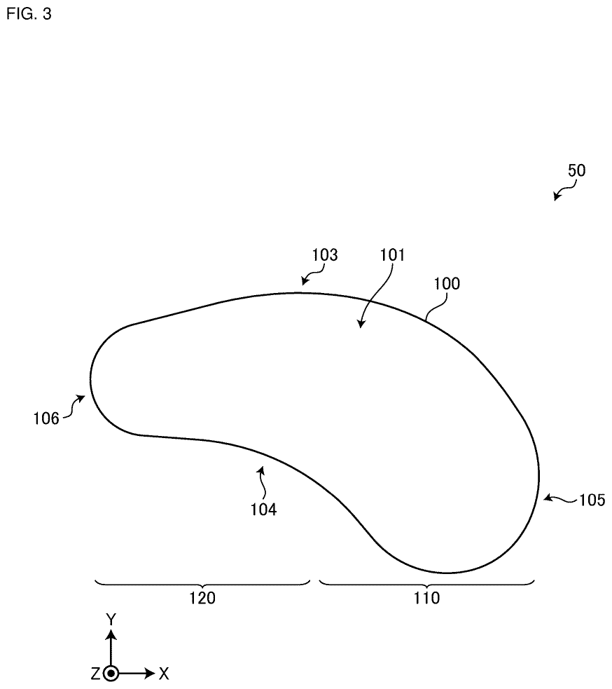

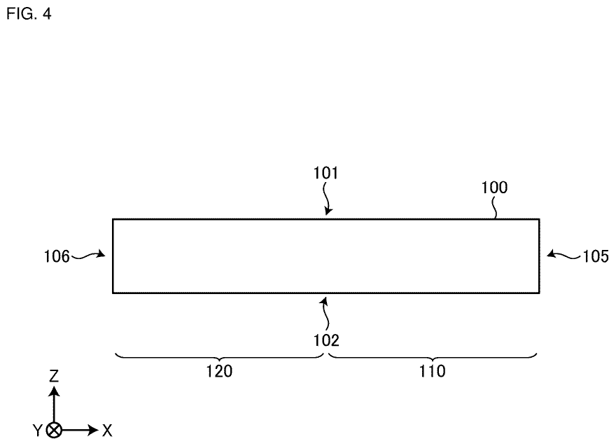

FIGS. 3 and 4 illustrate the outward appearance of the wireless power receiving device according to the embodiment. Components for implementing the wireless power receiving device 50 are accommodated in a housing 100. Although reference will be made to an X-axis direction, a Y-axis direction, and a Z-axis direction in the following description to facilitate understanding of the shape of the wireless power receiving device 50, the X-axis, the Y-axis, and the Z-axis simply mean three mutually orthogonal axes.

The Z-axis direction corresponds to an example of “one direction” according to the present disclosure.

The housing 100 has a face 101, a face 102, a face 103, a face 104, a face 105, and a face 106. The housing 100 has a shape that conforms to the shape of the human auricle.

The face 101 and the face 102 are faces parallel to the X-Y plane, and separated by a predetermined distance in the Z-axis direction. The face 101 and the face 102 are parallel and opposite to each other. The face 103 connects to an edge of each of the faces 101 and 102 that is located at the distal side in the Y-axis direction. The face 104 connects to an edge of each of the faces 101 and 102 that is located at the proximal side in the Y-axis direction. The face 105 connects to an edge of the faces 101 and 102 that is located at the distal side in the X-axis direction. The face 106 connects to an edge of each of the faces 101 and 102 that is located at the proximal side in the X-axis direction. The face 103, the face 104, the face 105, and the face 106 are each perpendicular to the X-Y plane.

The faces 101 and 102 each have a length in the Y-axis direction that is greater at the distal side in the X-axis direction than at the proximal side in the X-axis direction. That is, the faces 101 and 102 are larger in a region 110 where the faces 101 and 102 connect to the face 105, than in a region 120 where the faces 101 and 102 connect to the face 106.

The components for implementing the wireless power receiving device 50 are accommodated in the housing 100. In a non-limiting example of the present disclosure, the housing 100 may be made of resin. In a non-limiting example of the present disclosure, the housing 100 may accommodate the components for implementing the wireless power receiving device 50, and may be hermetically sealed.

### Internal Structure of Wireless Power Receiving Device

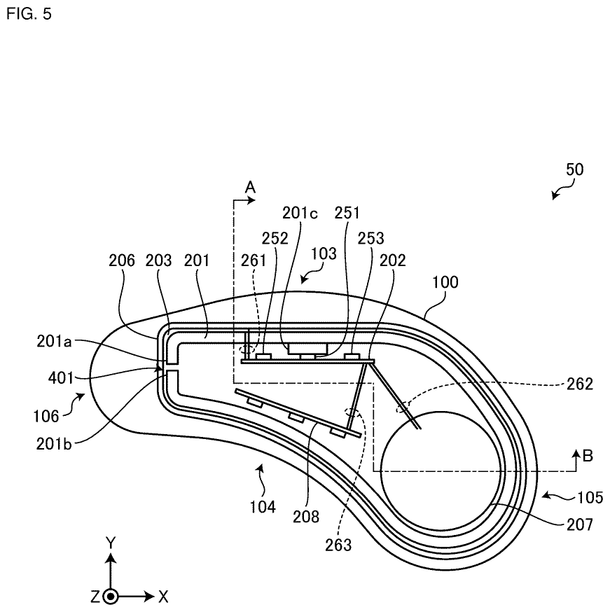

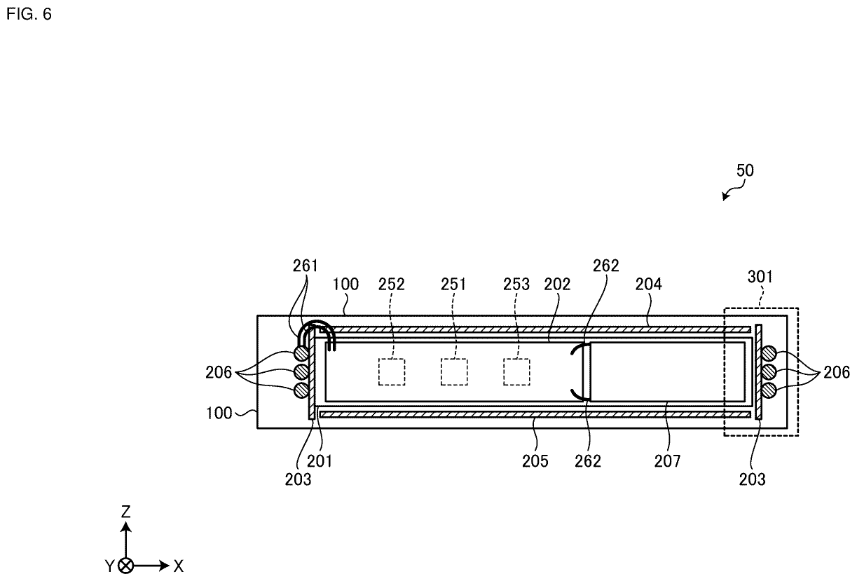

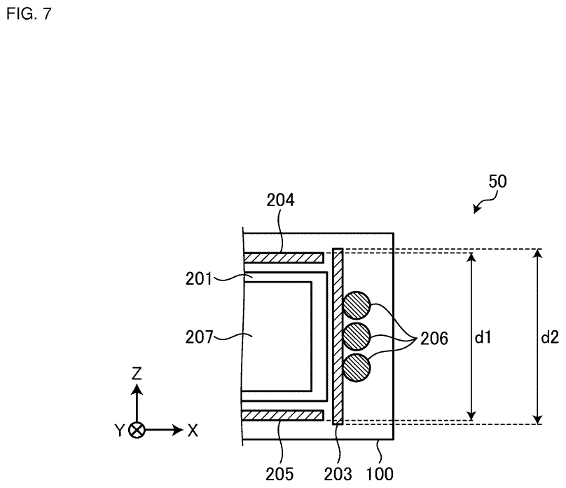

FIGS. 5, 6, and 7 illustrate the internal structure of the wireless power receiving device. FIG. 5 illustrates the wireless power receiving device 50 as viewed in a direction opposite to the Z-axis direction, with the face 101 (see FIGS. 3 and 4) of the housing 100 removed. FIG. 6 is a cross-sectional view taken along a line A-B in FIG. 5. FIG. 7 is an enlarged view of a region 301 in FIG. 6.

The housing 100 accommodates a thermally conductive member 201, a power-receiving circuit board 202, a first magnetic sheet 203, a second magnetic sheet 204, a third magnetic sheet 205, a power receiving coil 206, a secondary battery 207, and a functional circuit board 208.

The power receiving coil 206 corresponds to the power receiving coil 71 illustrated in FIG. 2. The secondary battery 207 corresponds to the secondary battery 82 illustrated in FIG. 2.

In a non-limiting example of the present disclosure, the thermally conductive member 201 may be made of a metal. In a non-limiting example of the present disclosure, the metal may be copper (Cu). Alternatively, the metal may be an alloy.

The thermally conductive member 201 has, in the circumferential direction about the Z-axis, one end 201a and the other end 201b that are positioned to face the face 106. The thermally conductive member 201 extends clockwise in the circumferential direction about the Z-axis along the face 103, the face 105, and the face 104 to define an annular shape. It is to be noted, however, that a gap 401 is present between the one end 201a and the other end 201b. That is, the thermally conductive member 201 has a C-shape as viewed in the Z-axis direction. This reduces the likelihood that a circulating current may flow through the thermally conductive member 201 in the circumferential direction about the Z-axis.

As described above, in the wireless power receiving device 50, the gap 401 is present between the one end 201a and the other end 201b of the thermally conductive member 201. This reduces the likelihood that a circulating current may flow through the thermally conductive member 201 in the circumferential direction about the Z-axis. This in turn allows the wireless power receiving device 50 to have reduced loss and improved power reception efficiency.

The thermally conductive member 201 has a projection 201c on the inner periphery of its portion that faces the face 103.

The first magnetic sheet 203 extends, along the outer periphery of the thermally conductive member 201, clockwise in the circumferential direction around the Z-axis to define an annular shape. That is, the first magnetic sheet 203 has an O-shape as viewed in the Z-axis direction. The first magnetic sheet 203 is in thermal contact with the thermally conductive member 201. For example, the first magnetic sheet 203 is in close contact with the thermally conductive member 201. As a result, heat from the thermally conductive member 201 is radiated toward the housing 100 via the first magnetic sheet 203.

In a non-limiting example of the present disclosure, the first magnetic sheet 203 may be a sintered ferrite body, or a fine-structured soft magnetic metal material bonded with resin. Generally, a sintered ferrite body has a high relative permeability (e.g., approximately 200), and a fine-structured soft magnetic metal material bonded with resin has a low relative permeability (e.g., approximately 50). As for cost, ferrite is expensive, and a fine-structured soft magnetic metal material bonded with resin is inexpensive. As for flexibility (bendability/workability), a fine-structured soft magnetic metal material bonded with resin has high flexibility, and a sintered ferrite body has low flexibility.

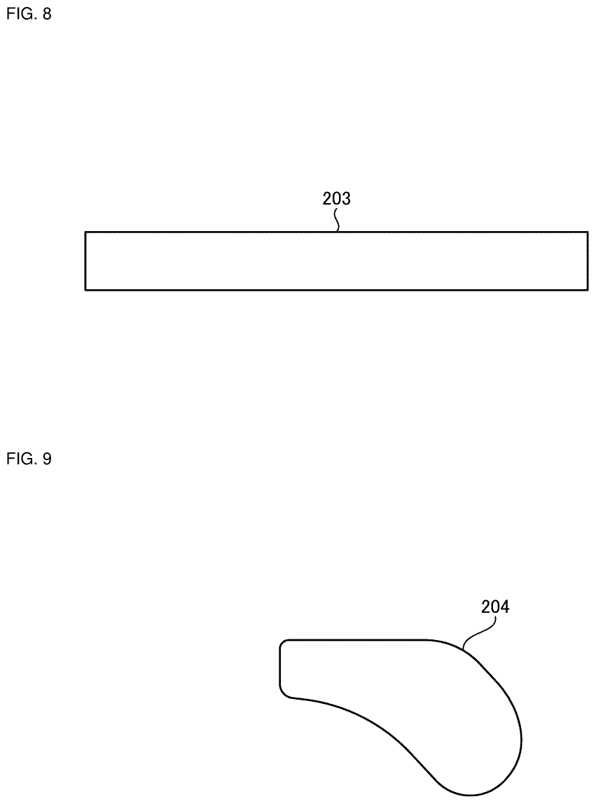

FIG. 8 illustrates an example of the first magnetic sheet. In an exemplary configuration, as illustrated in FIG. 8, the first magnetic sheet 203 may be in the form of a strip. In an exemplary configuration, the first magnetic sheet 203 in the form of a strip may be wound (e.g., bonded) on the outer periphery of the thermally conductive member 201 in the circumferential direction about the Z-axis.

Now, referring again to FIGS. 5 and 6, the power receiving coil 206 is wound around the outer periphery of the first magnetic sheet 203. Each end of the power receiving coil 206 is electrically connected to the power-receiving circuit board 202 via a wiring line 261.

The power-receiving circuit board 202 includes the resonant capacitor 72 (see FIG. 2), the resonance tuning circuit 62 (see FIG. 2), the rectifying and smoothing circuit 63 (see FIG. 2), the voltage conversion circuit 64 (see FIG. 2), the charging control circuit 65 (see FIG. 2), and the charging circuit 81 (see FIG. 2). The power-receiving circuit board 202 converts the resonant current of the power-receiving resonant circuit (the power receiving coil 206 and the resonant capacitor 72) into a direct current to supply power to the load (the secondary battery 207).

In the wireless power receiving device 50, the power-receiving circuit board 202 includes the charging circuit 81 configured to charge the secondary battery 207. This allows for repeated use without battery replacement.

The power-receiving circuit board 202 is disposed in a location inward of the thermally conductive member 201 and where the power-receiving circuit board 202 faces the face 103. The power-receiving circuit board 202 is positioned such that its first major face (the major face at the distal side in the Y-axis direction; the upper major face in FIG. 5) faces the thermally conductive member 201. That is, the first major face of the power-receiving circuit board 202 is positioned perpendicular to the X-Y plane and parallel to the Z-axis.

The above-mentioned configuration of the wireless power receiving device 50, in which the first major face of the power-receiving circuit board 202 is positioned perpendicular to the X-Y plane and parallel to the Z-axis, allows for increased internal space of the wireless power receiving device 50 in comparison to a case where the first major face of the power-receiving circuit board 202 is positioned parallel to the X-Y plane and perpendicular to the Z-axis. In other words, the above-mentioned configuration of the wireless power receiving device 50, in which the first major face of the power-receiving circuit board 202 is positioned perpendicular to the X-Y plane and parallel to the Z-axis, allows for greater miniaturization of the wireless power receiving device 50 in comparison to a case where the first major face of the power-receiving circuit board 202 is positioned parallel to the X-Y plane and perpendicular to the Z-axis.

A heat-generating electronic component 251, an electronic component 252, and an electronic component 253 are mounted on the first major face of the power-receiving circuit board 202. In a non-limiting example of the present disclosure, each of the heat-generating electronic component 251, the electronic component 252, and the electronic component 253 may be a semiconductor device.

The heat-generating electronic component 251 is an electronic component that generates the greatest amount of heat among the components of the wireless power receiving device 50. In a non-limiting example of the present disclosure, the heat-generating electronic component 251 may be a semiconductor device provided with the voltage conversion circuit 64 (e.g., a switching regulator).

Each of the resonance tuning circuit 62 (see FIG. 2), the rectifying and smoothing circuit 63 (see FIG. 2), the charging control circuit 65 (see FIG. 2), and the charging circuit 81 (see FIG. 2) is provided in the electronic component 252 or the electronic component 253.

The heat-generating electronic component 251 is in thermal contact with the projection 201c of the thermally conductive member 201. For example, a first major face (the major face at the distal side in the Y-axis direction; the upper major face in FIG. 5) of the heat-generating electronic component 251 is in close contact with the projection 201c of the thermally conductive member 201.

In the wireless power receiving device 50, the first major face of the power-receiving circuit board 202 is positioned perpendicular to the X-Y plane and parallel to the Z-axis as described above. This allows for easy contact between the heat-generating electronic component 251 and the thermally conductive member 201 in comparison to a case where the first major face of the power-receiving circuit board 202 is positioned parallel to the X-Y plane and perpendicular to the Z-axis.

Due to the thermal contact of the heat-generating electronic component 251 with the projection 201c of the thermally conductive member 201, heat from the heat-generating electronic component 251 is conducted to the thermally conductive member 201. Once conducted to the thermally conductive member 201, the heat spreads throughout the entire thermally conductive member 201. After spreading throughout the entire thermally conductive member 201, the heat is conducted throughout the entire first magnetic sheet 203.

In the wireless power receiving device 50, the heat from the heat-generating electronic component 251 spreads throughout the entire thermally conductive member 201, and spreads via the first magnetic sheet 203 to the face 103, the face 104, the face 105, and the face 106 of the housing 100. This makes it possible to reduce a localized increase in the temperature of the surface of the housing 100.

The secondary battery 207 is disposed in a location inward of the thermally conductive member 201 and where the secondary battery 207 faces the face 105.

In the wireless power receiving device 50, the secondary battery 207 is disposed inward of the thermally conductive member 201 as described above. This allows for miniaturization of the wireless power receiving device 50.

In an exemplary configuration, the secondary battery 207 may be a coin battery or a button battery.

In the wireless power receiving device 50, the secondary battery 207 is a button battery or a coin battery. This allows for miniaturization of the wireless power receiving device 50 as an electronic device, which makes the wireless power receiving device 50 suitable for use as a hearing aid.

The secondary battery 207 is electrically connected to the power-receiving circuit board 202 via a wiring line 262. The secondary battery 207 is charged via the wiring line 262 when the power-receiving circuit board 202 is receiving power.

The functional circuit board 208 includes the functional circuit 83 (see FIG. 2). In a non-limiting example of the present disclosure, when the wireless power receiving device according to the present disclosure is used for a hearing aid, the functional circuit board 208 may be a circuit board configured to amplify an audio signal and output the amplified audio signal.

The functional circuit board 208 is disposed in a location inward of the thermally conductive member 201 and where the functional circuit board 208 faces the face 104. Further, the functional circuit board 208 is positioned such that its first major face (the major face at the proximal side in the Y-axis direction; the lower major face in FIG. 5) faces the thermally conductive member 201. That is, the first major face of the functional circuit board 208 is positioned perpendicular to the X-Y plane and parallel to the Z-axis.

The above-mentioned configuration of the wireless power receiving device 50, in which the first major face of the functional circuit board 208 is positioned perpendicular to the X-Y plane and parallel to the Z-axis, allows for increased internal space of the wireless power receiving device 50 in comparison to a case where the first major face of the functional circuit board 208 is positioned parallel to the X-Y plane and perpendicular to the Z-axis. In other words, the above-mentioned configuration of the wireless power receiving device 50, in which the first major face of the functional circuit board 208 is positioned perpendicular to the X-Y plane and parallel to the Z-axis, allows for greater miniaturization of the wireless power receiving device 50 in comparison to a case where the first major face of the functional circuit board 208 is positioned parallel to the X-Y plane and perpendicular to the Z-axis.

The functional circuit board 208 is electrically connected to the power-receiving circuit board 202 via a wiring line 263. The functional circuit board 208 is configured to operate by receiving power supplied from the secondary battery 207 via the wiring line 263, the power-receiving circuit board 202, and the wiring line 262.

The second magnetic sheet 204 is disposed at a first opening of the thermally conductive member 201 (an opening at the distal side in the Z-axis direction; an opening at the side facing the face 101), and covers the first opening of the thermally conductive member 201. The third magnetic sheet 205 is disposed at a second opening of the thermally conductive member 201 (an opening at the proximal side in the Z-axis direction; an opening at the side facing the face 102), and covers the second opening of the thermally conductive member 201.

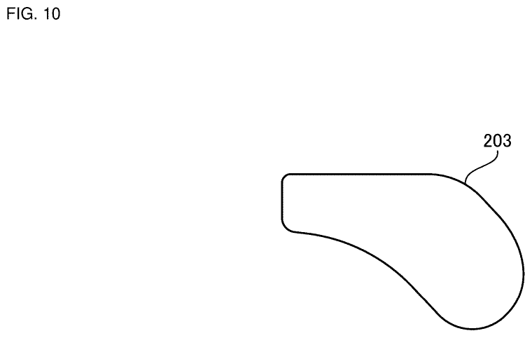

FIG. 9 illustrates an example of the second magnetic sheet. FIG. 10 illustrates an example of the third magnetic sheet.

In an exemplary configuration, the first magnetic sheet 203 may have a relative permeability greater than the relative permeability of each of the second magnetic sheet 204 and the third magnetic sheet 205. In an exemplary configuration, the first magnetic sheet 203 may be a sintered ferrite body, and each of the second magnetic sheet 204 and the third magnetic sheet 205 may be a fine-structured soft magnetic metal material bonded with resin.

As will be described later, the first magnetic sheet 203 forms magnetic coupling with a power transmitting coil 501 (described later) or a power transmitting coil 521 (described later), whereas the second magnetic sheet 204 and the third magnetic sheet 205 form an electromagnetic seal. Accordingly, the first magnetic sheet 203 preferably has a high relative permeability to increase magnetic coupling and improve power reception efficiency, whereas the second magnetic sheet 204 and the third magnetic sheet 205 do not need to have a high relative permeability.

As previously mentioned, a sintered ferrite body is expensive, and a fine-structured soft magnetic metal material bonded with resin is inexpensive.

Accordingly, in an exemplary configuration, the first magnetic sheet 203 may be a sintered ferrite body, and each of the second magnetic sheet 204 and the third magnetic sheet 205 may be a fine-structured soft magnetic metal material bonded with resin.

In the wireless power receiving device 50, when the first magnetic sheet 203 is a sintered ferrite body as described above, this allows for increased magnetic coupling with the power transmitting coil 501 or the power transmitting coil 521, and consequently improved power reception efficiency. Further, in the wireless power receiving device 50, when each of the second magnetic sheet 204 and the third magnetic sheet 205 is a fine-structured soft magnetic metal material bonded with resin as described above, this allows for reduced cost.

Referring now to FIG. 7, the end portion at the distal side in the Z-axis direction of the first magnetic sheet 203 is located closer to the distal side in the Z-axis direction than is the first major face at the distal side in the Z-axis direction of the second magnetic sheet 204. The end portion at the proximal side in the Z-axis direction of the first magnetic sheet 203 is located closer to the proximal side in the Z-axis direction than is the first major face at the proximal side in the Z-axis direction of the third magnetic sheet 205. In other words, the first magnetic sheet 203 has a width d2 in the Z-axis direction greater than a distance d1, which is the distance between the first major face of the second magnetic sheet 204 and the first major face of the third magnetic sheet 205.

The above-mentioned configuration of the wireless power receiving device 50 makes it possible to reduce the likelihood that magnetic flux from the power transmitting coil 501 or the power transmitting coil 521 may flow into the wireless power receiving device 50 through the gap between the first magnetic sheet 203 and the second magnetic sheet 204 and through the gap between the first magnetic sheet 203 and the third magnetic sheet 205. The above-mentioned configuration of the wireless power receiving device 50 therefore makes it possible to reduce magnetic flux linkage with the power-receiving circuit board 202, the secondary battery 207, and the functional circuit board 208, reduce generation of heat by the power-receiving circuit board 202, the secondary battery 207, and the functional circuit board 208, and reduce electromagnetic interference on the power-receiving circuit board 202, the secondary battery 207, and the functional circuit board 208.

First Example of Magnetic Fluxes Linking with Wireless Power Receiving Device

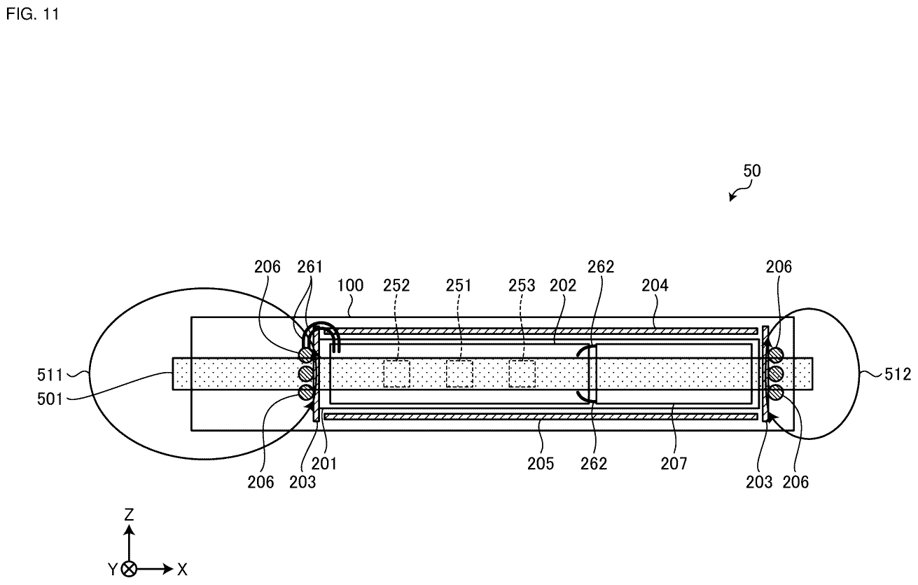

FIG. 11 illustrates a first example of magnetic fluxes that link with the wireless power receiving device. In FIG. 11, the power transmitting coil 501 has an annular shape extending in the circumferential direction about the Z-axis, and faces the face 106, the face 103, the face 105, and the face 104 (see, for example, FIG. 3).

For example, as indicated by an arrow 511, a magnetic flux flows from the end portion at the distal side in the Z-axis direction of the first magnetic sheet 203, travels counterclockwise in the X-Z plane to loop around the power receiving coil 206 and the power transmitting coil 501, and then reaches the end portion at the proximal side in the Z-axis direction of the first magnetic sheet 203. Further, for example, as indicated by an arrow 512, a magnetic flux flows from the end portion at the distal side in the Z-axis direction of the first magnetic sheet 203, travels clockwise in the X-Z plane to loop around the power receiving coil 206 and the power transmitting coil 501, and then reaches the end portion at the proximal side in the Z-axis direction of the first magnetic sheet 203.

Accordingly, the first magnetic sheet 203 is configured to form a magnetic path that allows for efficient magnetic flux linkage with the power receiving coil 206.

The above-mentioned configuration makes it possible to improve the power reception efficiency of the wireless power receiving device 50.

The above-mentioned configuration also makes it possible for the first magnetic sheet 203 to reduce magnetic flux linkage with the thermally conductive member 201, and consequently reduce the occurrence of eddy currents in the thermally conductive member 201.

The above-mentioned configuration therefore allows the wireless power receiving device 50 to have reduced loss and improved power reception efficiency.

Second Example of Magnetic Fluxes Linking with Wireless Power Receiving Device

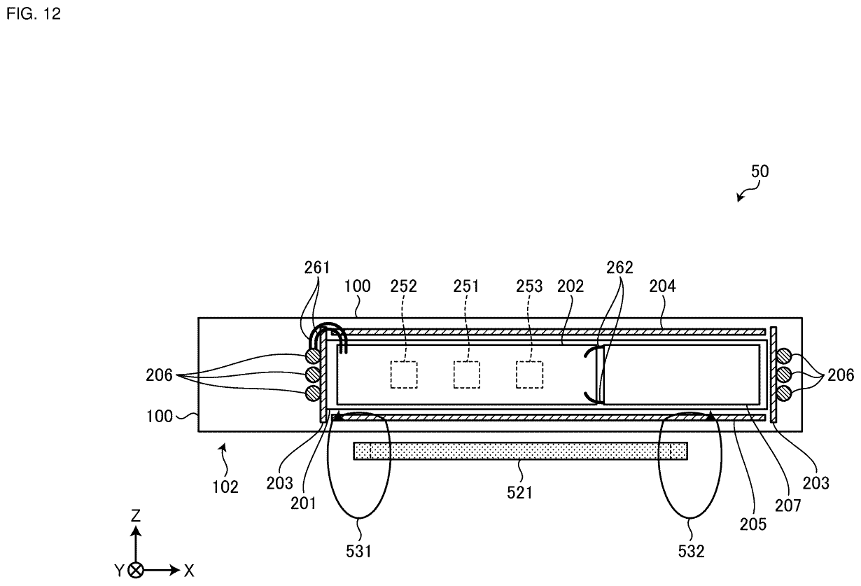

FIG. 12 illustrates a second example of magnetic fluxes that link with the wireless power receiving device. In FIG. 12, the power transmitting coil 521 is parallel to the X-Y plane, and faces the face 102 (see, for example, FIG. 3).

For example, as indicated by an arrow 531, a magnetic flux flows from the third magnetic sheet 205 to travel counterclockwise in a loop in the X-Z plane, passes through the interior of the power transmitting coil 521, and then reaches the third magnetic sheet 205. Further, for example, as indicated by an arrow 532, a magnetic flux flows from the third magnetic sheet 205 to travel clockwise in a loop in the X-Z plane, passes through the interior of the power transmitting coil 521, and then reaches the third magnetic sheet 205.

Accordingly, the third magnetic sheet 205 is configured to allow for reduced magnetic flux linkage with the power-receiving circuit board 202, the secondary battery 207, and the functional circuit board 208.

The above-mentioned configuration of the wireless power receiving device 50 makes it possible to reduce electromagnetic interference on the power-receiving circuit board 202, the secondary battery 207, and the functional circuit board 208.

Although not illustrated in FIG. 12, a magnetic flux can arise that flows from the first magnetic sheet 203 to loop around the power receiving coil 206, passes through the interior of the power transmitting coil 521, and then reaches the first magnetic sheet 203. This allows the wireless power receiving device 50 to be charged from the power transmitting coil 521.

### Advantageous Effects

[1] Due to the thermal contact of the heat-generating electronic component 251 with the projection 201c of the thermally conductive member 201, heat from the heat-generating electronic component 251 is conducted to the thermally conductive member 201. Once conducted to the thermally conductive member 201, the heat spreads throughout the entire thermally conductive member 201. After spreading throughout the entire thermally conductive member 201, the heat is conducted throughout the entire first magnetic sheet 203.

In the wireless power receiving device 50, the heat from the heat-generating electronic component 251 spreads throughout the entire thermally conductive member 201, and spreads via the first magnetic sheet 203 to the face 103, the face 104, the face 105, and the face 106 of the housing 100. This makes it possible to reduce a localized increase in the temperature of the surface of the housing 100.

[2] The end portion at the distal side in the Z-axis direction of the first magnetic sheet 203 is located closer to the distal side in the Z-axis direction than is the first major face at the distal side in the Z-axis direction of the second magnetic sheet 204. The end portion at the proximal side in the Z-axis direction of the first magnetic sheet 203 is located closer to the proximal side in the Z-axis direction than is the first major face at the proximal side in the Z-axis direction of the third magnetic sheet 205. In other words, the first magnetic sheet 203 has the width d2 in the Z-axis direction greater than the distance d1, which is the distance between the first major face of the second magnetic sheet 204 and the first major face of the third magnetic sheet 205.

The above-mentioned configuration of the wireless power receiving device 50 makes it possible to reduce the likelihood that magnetic flux from the power transmitting coil 501 or the power transmitting coil 521 may flow into the wireless power receiving device 50 through the gap between the first magnetic sheet 203 and the second magnetic sheet 204 and through the gap between the first magnetic sheet 203 and the third magnetic sheet 205. The above-mentioned configuration of the wireless power receiving device 50 therefore makes it possible to reduce magnetic flux linkage with the power-receiving circuit board 202, the secondary battery 207, and the functional circuit board 208, reduce generation of heat by the power-receiving circuit board 202, the secondary battery 207, and the functional circuit board 208, and reduce electromagnetic interference on the power-receiving circuit board 202, the secondary battery 207, and the functional circuit board 208.

[3] The previously mentioned configuration of the wireless power receiving device 50, in which the first major face of the power-receiving circuit board 202 is positioned perpendicular to the X-Y plane and parallel to the Z-axis, allows for increased internal space of the wireless power receiving device 50 in comparison to a case where the first major face of the power-receiving circuit board 202 is positioned parallel to the X-Y plane and perpendicular to the Z-axis. In other words, the previously mentioned configuration of the wireless power receiving device 50, in which the first major face of the power-receiving circuit board 202 is positioned perpendicular to the X-Y plane and parallel to the Z-axis, allows for greater miniaturization of the wireless power receiving device 50 in comparison to a case where the first major face of the power-receiving circuit board 202 is positioned parallel to the X-Y plane and perpendicular to the Z-axis.

[4] In an exemplary configuration, the first magnetic sheet 203 may be a sintered ferrite body, and each of the second magnetic sheet 204 and the third magnetic sheet 205 may be a fine-structured soft magnetic metal material bonded with resin.

In the wireless power receiving device 50, the first magnetic sheet 203 is a sintered ferrite body. This allows for increased magnetic coupling with the power transmitting coil 501 or the power transmitting coil 521, and consequently improved power reception efficiency. Further, in the wireless power receiving device 50, each of the second magnetic sheet 204 and the third magnetic sheet 205 is a fine-structured soft magnetic metal material bonded with resin. This allows for reduced cost.

[5] In the wireless power receiving device 50, the magnetic field generated from the power transmitting coil has a frequency of 6.78 MHz or 13.56 MHz in the ISM band. This allows for reduced electromagnetic interference.

[6] In the wireless power receiving device 50, the secondary battery 207 is disposed inward of the thermally conductive member 201. This allows for miniaturization of the wireless power receiving device 50.

[7] In the wireless power receiving device 50, the secondary battery 207 is a button battery or a coin battery. This allows for miniaturization of the wireless power receiving device 50 as an electronic device, which makes the wireless power receiving device 50 suitable for use as a hearing aid.

[8] In the wireless power receiving device 50, the power-receiving circuit board 202 includes the charging circuit configured to charge the secondary battery 207. This allows for repeated use without battery replacement.

[9] In the wireless power receiving device 50, the gap 401 is present between the one end 201a and the other end 201b of the thermally conductive member 201. This reduces the likelihood that a circulating current may flow through the thermally conductive member 201 in the circumferential direction about the Z-axis. This in turn allows the wireless power receiving device 50 to have reduced loss and improved power reception efficiency.

### Exemplary Configurations of Present Disclosure

The present disclosure may also employ the configurations described below.

(1) A wireless power receiving device comprising a thermally conductive member having an annular shape, the thermally conductive member extending in a circumferential direction about one direction; a first magnetic sheet extending along an outer periphery of the thermally conductive member and in thermal contact with the thermally conductive member; a second magnetic sheet covering an opening at one side in the one direction of the thermally conductive member; and a third magnetic sheet covering an opening at a side opposite to the one side in the one direction of the thermally conductive member. The wireless power receiving device further comprises a power receiving coil wound around an outer periphery of the first magnetic sheet; a power-receiving circuit board disposed inward of the thermally conductive member and electrically connected to the power receiving coil, the power receiving circuit board being configured to rectify and convert a resonant current induced in the power receiving coil into a direct current to supply power to a load; and a heat-generating electronic component mounted to the power-receiving circuit board and in thermal contact with the thermally conductive member. The thermally conductive member is configured to conduct heat generated from the heat-generating electronic component to the first magnetic sheet, and the first magnetic sheet has a length in the one direction greater than a distance between a major face of the second magnetic sheet and a major face of the third magnetic sheet. The major face of the second magnetic sheet is a major face at the one side in the one direction. The major face of the third magnetic sheet is a major face at the side opposite to the one side in the one direction. The first magnetic sheet is configured to form a main magnetic flux path and to thermally radiate the heat generated from the heat-generating electronic component. The main magnetic flux path is a magnetic path that exhibits greater magnetic coupling to a magnetic flux generated from a power transmitting coil external to the wireless power receiving device than a magnetic path formed in the second magnetic sheet or the third magnetic sheet.

(2) The wireless power receiving device according to (1) above, wherein the power-receiving circuit board has a major face disposed in parallel to the one direction.

(3) The wireless power receiving device according to (1) or (2) above, wherein the first magnetic sheet has a relative permeability greater than a relative permeability of the second magnetic sheet or the third magnetic sheet.

(4) The wireless power receiving device according to any one of (1) to (3) above, wherein a magnetic field generated from the power transmitting coil has a frequency of 6.78 MHz or 13.56 MHz in an Industrial, Scientific and Medical (ISM) band.

(5) The wireless power receiving device according to any one of (1) to (4) above, further comprising a secondary battery disposed inward of the thermally conductive member.

(6) The wireless power receiving device according to (5) above, wherein the secondary battery is a coin battery or a button battery.

(7) The wireless power receiving device according to (5) or (6) above, wherein the power-receiving circuit board includes a charging circuit configured to charge the secondary battery.

(8) The wireless power receiving device according to any one of (1) to (7) above, wherein the thermally conductive member comprises copper, and has a gap between one end in the circumferential direction and an other end in the circumferential direction.

The embodiments described above are intended to facilitate understanding of the present disclosure, and not to be construed as limiting of the present disclosure. The present disclosure may be altered/modified without departing from the spirit and scope thereof, and the present disclosure also includes equivalents thereof.

What is claimed is:

1. A wireless power receiving device comprising:
a thermally conductive member having an annular shape, the thermally conductive member extending in a circumferential direction about one direction;
a first magnetic sheet extending along an outer periphery of the thermally conductive member and in thermal contact with the thermally conductive member;
a second magnetic sheet covering an opening at one side in the one direction of the thermally conductive member;
a third magnetic sheet covering an opening at a side opposite to the one side in the one direction of the thermally conductive member;
a power receiving coil wound around an outer periphery of the first magnetic sheet;
a power-receiving circuit board that is inward of the thermally conductive member and electrically connected to the power receiving coil, the power-receiving circuit board being configured to rectify and convert a resonant current induced in the power receiving coil into a direct current to supply power to a load; and
a heat-generating electronic component mounted to the power-receiving circuit board and in thermal contact with the thermally conductive member,
wherein
the thermally conductive member is configured to conduct heat generated from the heat-generating electronic component to the first magnetic sheet, and
the first magnetic sheet has a length in the one direction greater than a distance between a major face of the second magnetic sheet and a major face of the third magnetic sheet, the major face of the second magnetic sheet being a major face at the one side in the one direction, the major face of the third magnetic sheet being a major face at the side opposite to the one side in the one direction, the first magnetic sheet being configured to form a main magnetic flux path and to thermally radiate the heat generated from the heat-generating electronic component, and the main magnetic flux path being a magnetic path that exhibits greater magnetic coupling to a magnetic flux generated from a power transmitting coil external to the wireless power receiving device than a magnetic path formed in the second magnetic sheet or the third magnetic sheet.

2. The wireless power receiving device according to claim 1, wherein
the power-receiving circuit board has a major face that is in parallel to the one direction.

3. The wireless power receiving device according to claim 1, wherein
the first magnetic sheet has a relative permeability greater than a relative permeability of the second magnetic sheet or the third magnetic sheet.

4. The wireless power receiving device according to claim 1, wherein
a magnetic field generated from the power transmitting coil has a frequency of 6.78 MHz or 13.56 MHz in an Industrial, Scientific and Medical (ISM) band.

5. The wireless power receiving device according to claim 1, further comprising
a secondary battery that is inward of the thermally conductive member.

6. The wireless power receiving device according to claim 5, wherein
the secondary battery is a coin battery or a button battery.

7. The wireless power receiving device according to claim 5, wherein
the power-receiving circuit board includes a charging circuit configured to charge the secondary battery.

8. The wireless power receiving device according to claim 1, wherein
the thermally conductive member comprises copper, and has a gap between one end in the circumferential direction and an other end in the circumferential direction.

9. The wireless power receiving device according to claim 2, wherein
the first magnetic sheet has a relative permeability greater than a relative permeability of the second magnetic sheet or the third magnetic sheet.

10. The wireless power receiving device according to claim 2, wherein
a magnetic field generated from the power transmitting coil has a frequency of 6.78 MHz or 13.56 MHz in an Industrial, Scientific and Medical (ISM) band.

11. The wireless power receiving device according to claim 3, wherein
a magnetic field generated from the power transmitting coil has a frequency of 6.78 MHz or 13.56 MHz in an Industrial, Scientific and Medical (ISM) band.

12. The wireless power receiving device according to claim 2, further comprising
a secondary battery that is inward of the thermally conductive member.

13. The wireless power receiving device according to claim 3, further comprising
a secondary battery that is inward of the thermally conductive member.

14. The wireless power receiving device according to claim 4, further comprising
a secondary battery that is inward of the thermally conductive member.

15. The wireless power receiving device according to claim 6, wherein
the power-receiving circuit board includes a charging circuit configured to charge the secondary battery.

16. The wireless power receiving device according to claim 2, wherein
the thermally conductive member comprises copper, and has a gap between one end in the circumferential direction and an other end in the circumferential direction.

17. The wireless power receiving device according to claim 2, wherein
the thermally conductive member comprises copper, and has a gap between one end in the circumferential direction and an other end in the circumferential direction.

18. The wireless power receiving device according to claim 3, wherein
the thermally conductive member comprises copper, and has a gap between one end in the circumferential direction and an other end in the circumferential direction.

19. The wireless power receiving device according to claim 4, wherein
the thermally conductive member comprises copper, and has a gap between one end in the circumferential direction and an other end in the circumferential direction.

20. The wireless power receiving device according to claim 5, wherein
the thermally conductive member comprises copper, and has a gap between one end in the circumferential direction and an other end in the circumferential direction.
